(19) United States
(12) Patent Application Publication
(10) Pub. No.: US 2025/0332938 A1
(43) Pub. Date: Oct. 30, 2025

(54) MULTIFUNCTIONAL ONBOARD CHARGER MODULE

(71) Applicant: GM Global Technology Operations LLC, Detroit, MI (US)

(72) Inventors: Minh-Khai Nguyen, Troy, MI (US); Lei Hao, Troy, MI (US); Chandra S. Namuduri, Troy, MI (US)

(73) Assignee: GM Global Technology Operations LLC, Detroit, MI (US)

(21) Appl. No.: 18/646,269

(22) Filed: Apr. 25, 2024

(51) Int. Cl. B60L 53/24; B60L 50/60; H02J 7/02; H02P 29/64

(52) U.S. Cl. CPC B60L 53/24; B60L 50/60; H02J 7/02; H02P 29/64; B60L 2210/10; B60L 2210/40

(57) ABSTRACT

An onboard charging system for an electric vehicle comprising a charging port configured to receive an alternating current (AC) power, a power outlet, a direct current (DC) battery selectively coupled to the charging port via a first switch and a second switch, a bidirectional inverter selectively coupled to the battery via a third switch, a fourth switch, and a fifth switch, an electric motor coupled to the bidirectional inverter and selectively coupled to the charging port via a sixth switch, a DC-AC converter selectively coupled to the electric motor via a seventh switch and an eighth switch and selectively coupled to the power outlet via a ninth switch, a tenth switch, and an eleventh switch, and a DC-DC converter coupled to the DC-AC converter and selectively coupled to the battery via a twelfth switch and a thirteenth switch, the charging port selectively coupled to the battery.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electric vehicles and, more particularly, to onboard charging systems of electric vehicles.

Electric vehicles use high-voltage batteries to power one or more electric machines and thereby deliver torque to the vehicle's driveline, either alone or in conjunction with an internal combustion engine. The term “plug-in vehicle” describes any vehicle, e.g., battery electric, hybrid electric, for instance by plugging a charging cable from the vehicle into a 120 VAC or 240 VAC wall socket.

An onboard charging module (OBCM) may be used to facilitate recharging of the high-voltage battery. A typical OBCM has the required electronic circuit hardware and control software to convert single-phase or three-phase alternating current (AC) grid voltage into a direct current (DC) voltage usable by the battery. Some of the electronic circuit hardware takes up a significant amount of space and/or adds a considerable amount of weight to the vehicle. Shortcomings of existing systems will be addressed by one or more aspects of the present disclosure.

### SUMMARY

An electric vehicle is provided and includes a charging port configured to receive an alternating current (AC) power, a power outlet configured to provide the AC power to one or more external devices, and a direct current (DC) battery selectively coupled to the charging port via a first switch and a second switch. The electric vehicle further including a bidirectional inverter configured to convert AC power to DC power and to convert DC power to AC power, the bidirectional inverter is selectively coupled to the battery via a third switch, a fourth switch, and a fifth switch. The electric vehicle further including an electric motor coupled to the bidirectional inverter and selectively coupled to the charging port via a sixth switch, a DC-AC converter selectively coupled to the electric motor via a seventh switch and an eighth switch and selectively coupled to the power outlet via a ninth switch, a tenth switch, and an eleventh switch, and a DC-DC converter coupled to the DC-AC converter and selectively coupled to the battery via a twelfth switch and a thirteenth switch. The charging port is selectively coupled to the bidirectional inverter, the electric motor, or the DC-AC converter via a fourteenth switch. The electric vehicle further including a processor configured to control operation of the first switch, the second switch, the third switch, the fourth switch, the fifth switch, the sixth switch, the seventh switch, the eighth switch, the ninth switch, the tenth switch, the eleventh switch, the twelfth switch, the thirteenth switch, and the fourteenth switch based on an operation mode of the electric vehicle.

The electric vehicle may include one or more of the following optional aspects. For example, one or more fuses may be disposed adjacent to a positive and a negative terminal of the battery.

According to at least one aspect, during a vehicle to vehicle DC boost mode of the electric vehicle, the processor causes the first switch, the second switch, the third switch, the seventh switch, the ninth switch, the tenth switch, the eleventh switch, the twelfth switch, and the thirteenth switch to be in an open position and the fourth switch, the fifth switch, the sixth switch, and the fourteenth switch to be in a closed position.

According to another aspect, during a vehicle to vehicle buck mode of the electric vehicle, the processor causes the first switch, the second switch, the third switch, the fourth switch, the fifth switch, the ninth switch, the tenth switch, and the eleventh switch to be in an open position and the sixth switch, the seventh switch, the eighth switch, the twelfth switch, the thirteenth switch, and the fourteenth switch, to be in a closed position.

According to at least one example, during a vehicle to load inverter module mode of the electric vehicle, the processor causes the first switch, the second switch, the third switch, the fourth switch, the fifth switch, the sixth switch, the seventh switch, the eighth switch, and the fourteenth switch to be in an open position and the ninth switch, the tenth switch, the eleventh switch, the twelfth switch, and the thirteenth switch to be in a closed position.

According to another example, during a vehicle to grid mode of the electric vehicle, the processor causes the first switch, the second switch, the third switch, the fourth switch, the fifth switch, the ninth switch, the tenth switch, and the eleventh switch to be in an open position and the sixth switch, the seventh switch, the eighth switch, the twelfth switch, the thirteenth switch, and the fourteenth switch to be in a closed position.

According to at least one aspect, during a vehicle to home mode of the electric vehicle, the processor causes the first switch, the second switch, the third switch, the fourth switch, the fifth switch, the ninth switch, the tenth switch, and the eleventh switch to be in an open position and the sixth switch, the seventh switch, the eighth switch, the twelfth switch, the thirteenth switch, and the fourteenth switch to be in a closed position.

According to another aspect, during an AC charging mode of the electric vehicle, the processor causes the third switch, the fourth switch, the fifth switch, the ninth switch, the tenth switch, the eleventh switch, the first switch, and the second switch to be in an open position and the twelfth switch, the thirteenth switch, the fourteenth switch, the sixth switch, the seventh switch, and the eighth switch to be in a closed position.

According to at least one example, during a propulsion mode of the electric vehicle, the processor causes the first switch, the second switch, the sixth switch, the seventh switch, the eighth switch, the ninth switch, the tenth switch, the eleventh switch, the twelfth switch, the thirteenth switch, and the fourteenth switch to be in an open position and first close the third switch and the fifth switch to pre-charge an inverter capacitor and then open the third switch and close the fourth switch.

According to another example, during a direct current fast charging mode of the electric vehicle, the processor causes the third switch, the fourth switch, the fifth switch, the sixth switch, the seventh switch, the eighth switch, the ninth switch, the tenth switch, the eleventh switch, the twelfth switch, the thirteenth switch, and the fourteenth switch to be in an open position and the first switch and the second switch to be in a closed position.

In another configuration, an onboard charging system for an electric vehicle is provided and includes a charging port configured to receive an alternating current (AC) power, a power outlet configured to provide the AC power to one or more external devices, and a direct current (DC) battery selectively coupled to the charging port via a first switch and a second switch. The onboard charging system further includes a bidirectional inverter configured to convert AC power to DC power and to convert DC power to AC power, the bidirectional inverter is selectively coupled to the battery via a third switch, a fourth switch, and a fifth switch and an electric motor coupled to the bidirectional inverter and selectively coupled to the charging port via a sixth switch. The onboard charging system further includes a DC-AC converter selectively coupled to the electric motor via a seventh switch and an eighth switch and selectively coupled to the power outlet via a ninth switch, a tenth switch, and an eleventh switch and a DC-DC converter coupled to the DC-AC converter and selectively coupled to the battery via a twelfth switch and a thirteenth switch. The charging port is selectively coupled to the battery via the thirteenth switch.

The onboard charging system may include one or more of the following optional features. For example, a positive terminal of the charging port is selectively coupled to a stator winding of the electric motor between the bidirectional inverter and the electric motor via the sixth switch and a negative terminal of the charging port is selectively coupled to half bridge switches via a fourteenth switch.

According to at least one aspect, a positive terminal of the charging port is selectively coupled to a stator winding of the electric motor between the bidirectional inverter and the electric motor via the sixth switch, and a negative terminal of the charging port is selectively coupled between capacitors of the bidirectional inverter via a fourteenth switch.

According to at least one example, a positive terminal of the charging port is selectively coupled to three sub switches via the sixth switch, the three sub switches are each selectively coupled to separate stator windings of the electric motor. The onboard charging system can further include a processor that is configured to monitor temperatures of the stator windings and selectively control the three sub switches to prevent any of the stator windings from exceeding a threshold temperature.

According to another example, a positive terminal of the charging port is selectively coupled to a neutral point of stator windings of the electric motor via the sixth switch, and a negative terminal of the charging port is selectively coupled to insulated gate bipolar transistors that are connected in parallel to the bidirectional inverter, the DC-AC converter, and the DC-DC converter via a fourteenth switch.

According to at least one aspect, a positive terminal of the charging port is selectively coupled to a neutral point of stator windings of the electric motor via the sixth switch, and a negative terminal of the charging port is selectively coupled between capacitors of the bidirectional inverter via a fourteenth switch.

According to another aspect, one or more fuses can be disposed adjacent to a positive and negative terminal of the battery.

According to at least one example, one or more pre-charge resistors are disposed between the third switch and the bidirectional inverter.

According to another example, the onboard charging system can further include a battery disconnect unit configured to be controlled by a processor and comprising one or more switches, one or more resistors, and one or more fuses.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle comprising an onboard charging system according to principles of the present disclosure;

FIG. 2 is a schematic of an onboard charging system in accordance with the principles of the present disclosure;

FIG. 3A is a schematic circuit diagram of an onboard charging system of the vehicle of FIG. 1 in accordance with the principles of the present disclosure;

FIG. 3B is a schematic circuit diagram of an onboard charging system of the vehicle of FIG. 1 in accordance with the principles of the present disclosure;

FIG. 3C is a schematic circuit diagram of an onboard charging system of the vehicle of FIG. 1 in accordance with the principles of the present disclosure;

FIG. 3D is a schematic circuit diagram of an onboard charging system of the vehicle of FIG. 1 in accordance with the principles of the present disclosure;

FIG. 3E is a schematic circuit diagram of an onboard charging system of the vehicle of FIG. 1 in accordance with the principles of the present disclosure; and

FIG. 3F is a schematic circuit diagram of an onboard charging system of the vehicle of FIG. 1 in accordance with the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “third,” “fourth,” “fifth,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “third,” “fourth,” and other numerical terms do not imply a sequence or order unless clearly indicated by the context. Thus, a third element, component, region, layer or section discussed below could be termed a fourth element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

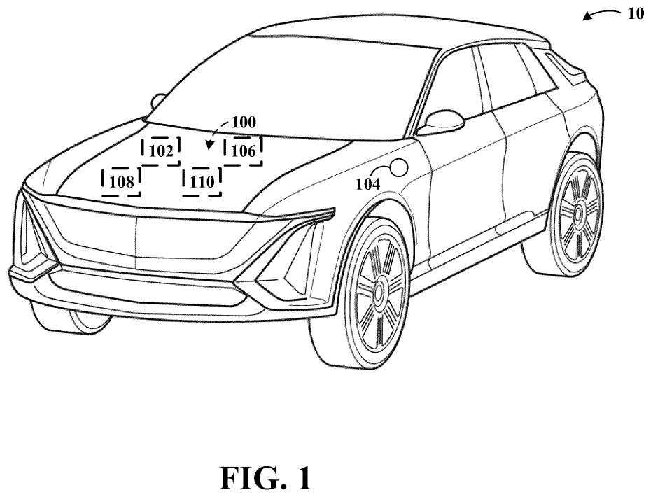

With reference to FIG. 1, a schematic diagram of a vehicle 10 is provided for use in conjunction with one or more principles of the present disclosure. The vehicle 10 includes an onboard charging system 100 comprising a processor 102, a charging port 104, a power outlet 106, a battery 108, and an electric motor 110. In at least one configuration, the vehicle 10 is a hybrid vehicle that utilizes an internal combustion engine and an electric motor. In another configuration, the vehicle 10 is an electric vehicle that only utilizes electric motors. The vehicle 10 may be configured to be connected, via the charging port 104, to a single-phase or three-phase alternating-current (AC) power source, for charging the battery 108. The electric motor 110 may be configured to receive power from the battery 108 to provide propulsion for the vehicle 10. In at least one configuration, the battery 108 may be configured to supply direct-current (DC) power to an inverter, which converts the DC power into three-phase AC power. The three-phase AC power is supplied to the electric motor 110 for propulsion of the vehicle 10.

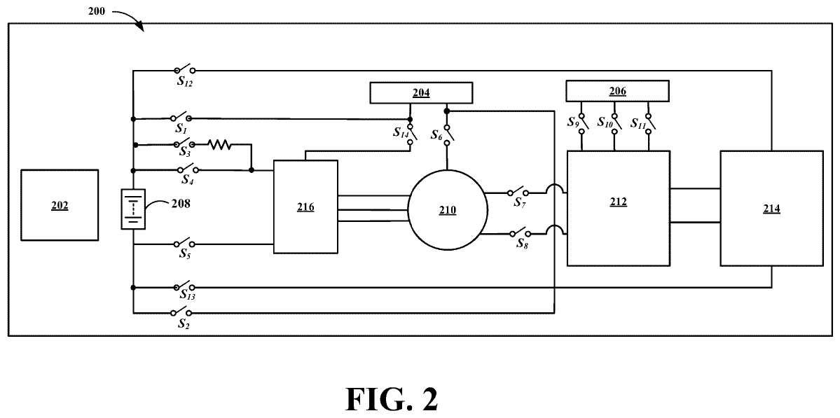

With reference to FIG. 2, an example of the onboard charger system 200 is illustrated in accordance with aspects of the present disclosure. As illustrated, the onboard charging system 200 includes a processor 202, a charging port 204, the power outlet 206, a battery 208, an electric motor 210, a DC-AC converter 212, a DC-DC converter 214, a bidirectional inverter 216, and one or more switches S₁-Sₙ.

The charging port 204 may be configured to receive a single-phase AC power, a three-phase AC power, or DC power (e.g., direct current fast charging) from a charging source. In one configuration, the single-phase AC power has a voltage between eighty-five and two-hundred and seventy volts. In another configuration, the three-phase AC power and/or direct current for fast charging has a voltage between three hundred and nine hundred volts. In one configuration, the charging port 204 includes one or more sensors (not shown) that are configured to detect that a charging source has been connected to the charging port 204. In one configuration, the sensors are in communication with the processor 202. As will be discussed in one or more configurations below, a positive terminal of the charging port 204 may be selectively coupled to the bidirectional inverter 216, the electric motor 210, and/or the DC-AC converter 212 via a fourteenth switch S₁₄. Additionally, the charging port 204 can be selectively coupled to the battery 208 via a first switch S₁ and a second switch S₂.

The power outlet 206 is selectively coupled to the DC-AC converter 212 via a ninth switch S₉, a tenth switch S₁₀, and an eleventh switch S₁₁. The power outlet 206 may be configured to provide split-phase AC power to one or more mobile devices while the vehicle is traveling and at rest, for example. In one configuration, the split-phase AC power has a voltage between one hundred and twenty and two hundred and seventy volts. The DC-AC converter 212 may also be selectively coupled to the electric motor 210 via a seventh switch S₇ and an eighth switch S₈.

The battery 208 may be a direct current (DC) battery that is a high voltage battery and has a capacity of greater than approximately three hundred volts. In one configuration, the battery is a Lithium-ion battery. The battery 208 can include one or more NCM (Lithium Nickel Manganese Cobalt Oxide) battery cells, one or more LFP (Lithium Iron Phosphate) battery cells and other types of battery cells.

The bidirectional inverter 216 is configured to convert AC power to DC power and to convert DC power to AC power. The bidirectional inverter 216 is selectively coupled to the DC battery 208 by a third switch S₃, a fourth switch S₄, and a fifth switch S₅. The term “bidirectional” indicates that the bidirectional inverter 216 can operate in both directions, allowing power to flow in and out of the battery 208.

In the AC-to-DC mode, or rectification mode, the bidirectional inverter 216 converts AC power from the electric motor 210 into DC power. The AC input from the electric motor 210 is connected to the bidirectional inverter 216, which is connected to the DC-AC converter 212 and the DC-DC converter 214. The isolated DC-DC converter 214 is connected to the battery 208 via a twelfth switch S₁₂ and a thirteenth switch S₁₃. A rectifier of the bidirectional inverter 216 converts the AC input into DC using power electronic switches (e.g., insulated gate bipolar transistors or IGBTs).

In the DC-to-AC mode, or inversion mode, the bidirectional inverter 216 converts DC power from the battery 208 into AC power. The DC output from the battery 208 is connected to the bidirectional inverter 216 via the fifth switch S₅. The inverter of the bidirectional inverter 216 converts the DC input into AC using power electronic switches (e.g., insulated gate bipolar transistors (IGBTs), wideband gap switches, or the like). For example, the bidirectional inverter 216 can use pulse-width modulation (PWM) techniques to convert the DC power into a high-frequency AC waveform. In some configurations, the bidirectional inverter 216 includes a control circuit that regulates the AC output voltage and frequency to match the requirements of the electric motor 210.

The onboard charging system 200 can utilize one or more electric motors 210 to provide propulsion to the electric vehicle 10 and to charge the battery 208, for example. In one configuration, the electric motor 210 is selectively coupled to the charging port 204 by a sixth switch S₆. In some configurations, AC power can be provided to stator windings of the electric motor 210 or to a neutral point of the stator windings of the electric motor 210. The stator winding can act as an inductor for the provided AC power.

The processor 202 controls the operation (i.e., opening and/or closing) of the switches of the onboard charging system 200 (i.e., opens and closes switches depending on the operation mode of the vehicle 10). Several operational modes of the onboard charging system 200 are provided below.

In a vehicle to vehicle (V2V) DC boost mode of the electric vehicle 10, the processor 202 first closes the third switch S₃ and the fifth switch S₅ to pre-charge a capacitor of the inverter 216 then opens the third switch S₃ and closes the fourth switch S₄, the fourteenth switch S₁₄, and the sixth switch S₆ allowing DC power to flow from the charging port 204 through the electric motor 210 and the bidirectional inverter 216, which provides DC power to the battery 208.

In a vehicle to vehicle (V2V) buck mode of the electric vehicle 10, the processor 202 closes the twelfth switch S₁₂, the thirteenth switch S₁₃, the fourteenth switch S₁₄, the sixth switch S₆, the seventh switch S₇, and the eighth switch S₅ allowing DC power to flow from the charging port 204 through the electric motor 210 and the bidirectional inverter 216. At this point, the DC-DC converter 214 can convert DC power to a voltage level that is compatible to the battery 208 and then charge the battery 208.

According to one aspect, in a vehicle-to-load inverter module (V2Lim) mode of the electric vehicle 10, the processor 202 closes the twelfth switch S₁₂, the thirteenth switch S₁₃, the ninth switch S₉, the tenth switch S₁₀, and the eleventh switch S₁₁ allowing DC power to flow from the DC-DC converter 214 to the DC-AC converter 212 so that AC power is provided to the power outlet 206.

According to another aspect, in a vehicle-to-load inverter module (V2Lim) mode during propulsion of the electric vehicle 10, the processor 202 closes the fourth switch S₄, the fifth switch S₅, the twelfth switch S₁₂, the thirteenth switch S₁₃, the ninth switch S₉, the tenth switch S₁₀, and the eleventh switch S₁₁ allowing DC power to flow from the battery 208 to the inverter 216 and the motor 210 to provide propulsion. Additionally, DC power flows from the DC-DC converter 214 to the DC-AC converter 212 so that AC power is provided to the power outlet 206.

According to another aspect, in a vehicle-to-load inverter module (V2Lim) mode, while charging the electric vehicle 10, the processor 202 closes the sixth switch S₆, the seventh switch S₇, the eighth switch S₈, the ninth switch S₉, the tenth switch S₁₀, the eleventh switch S₁₁, the twelfth switch S₁₂, the thirteenth switch S₁₃, and the fourteenth switch S₁₄ allowing AC power to flow from the charging port to the inverter 216 and the motor 210. The inverter 216 can be in a rectifier mode while the stator windings of the motor 210 function as an inductor to convert AC power to DC power. Then, the DC-DC converter 214 can convert the DC power to a voltage level which is compatible with the battery 208 to charge the battery 208. Additionally, DC power can flow out of the motor 208 and the inverter 216 and flow from the DC-AC converter 212 to the power outlet 206 so that AC power is provided to the power outlet 206.

In a vehicle to grid (V2G) mode or a vehicle to home (V2H) mode of the electric vehicle 10, the processor 202 switches the twelfth switch S₁₂, the thirteenth switch S₁₃, the fourteenth switch S₁₄, the sixth switch S₆, the seventh switch S₇, and the eighth switch S₈ allowing DC power to flow from the battery 208 to the DC-DC converter 214 through the DC-AC converter 212 to the electric motor 210 and the inverter 216 where DC power is converted to AC power and output to the grid or a home through the charging port 204.

In an AC charging mode of the electric vehicle 10, the processor 202 closes the twelfth switch S₁₂, the thirteenth switch S₁₃, the fourteenth switch S₁₄, the sixth switch S₆, the seventh switch S₇, and the eighth switch S₅ allowing AC power to flow from the charging port 204 to the electric motor 210 and the inverter 216. The inverter 216 can be in a rectifier mode while the stator winding of the motor 210 can function as an inductor to convert AC power to DC power. At this point, the DC-DC converter 214 can convert DC power to a voltage level that is compatible with the battery 208 to charge the battery 208.

In a propulsion mode of the electric vehicle 10, the processor 202 first closes the third switch S₃ and the fifth switch S₅ to pre-charge a capacitor of the inverter 216. Then, the processor 202 can open the third switch S₃ and close the fourth switch S₄ to allow DC power to flow from the battery 208 through the bidirectional inverter 216, which provides AC power to the electric motor 210.

In a normal direct current fast charging (DCFC) mode of the vehicle 10, the processor 202 closes the first switch S₁ and the second switch S₂ allowing DC power to flow from the charging port 204 to the battery 208.

In some configurations, more than one mode may be simultaneously utilized. For instance, the processor 202 can close the twelfth switch S₁₂, the thirteenth switch S₁₃, the ninth switch S₉, the tenth switch S₁₀, the eleventh switch S₁₁, the first switch S₁, and the second switch S₂ so that a normal DCFC and a vehicle-to-load inverter module mode can be utilized at the same time. In other words, a passenger can utilize the power outlet 206 to charge a personal device (e.g., a cell phone or computer) while charging the battery 208 of the vehicle 10.

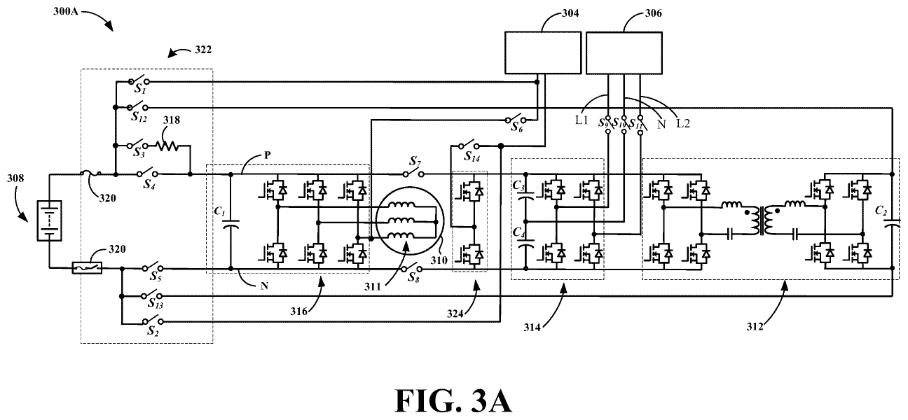

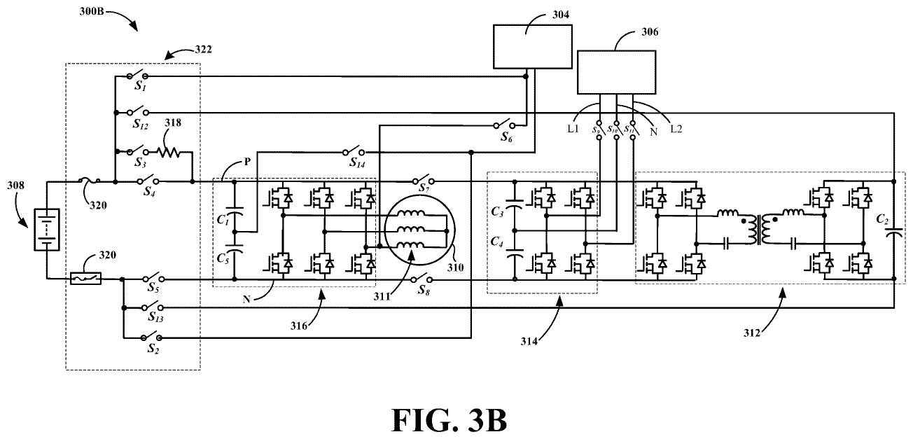

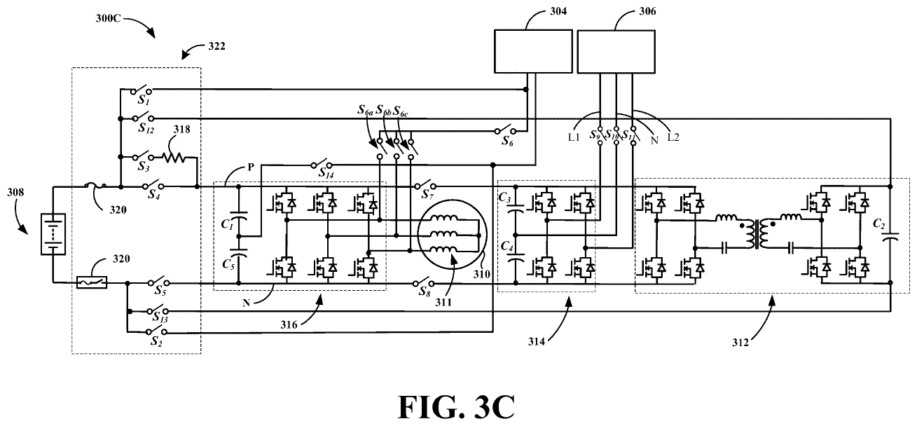

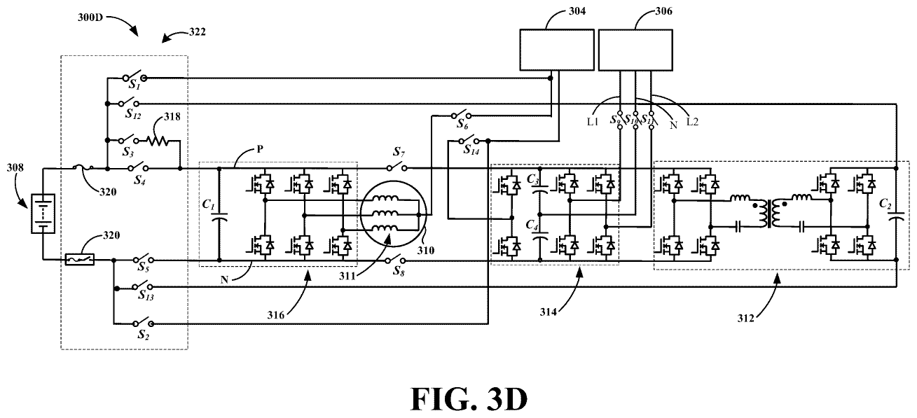

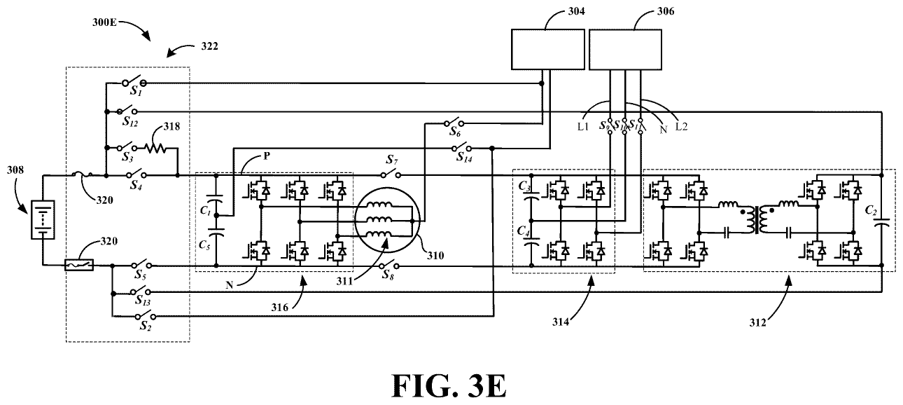

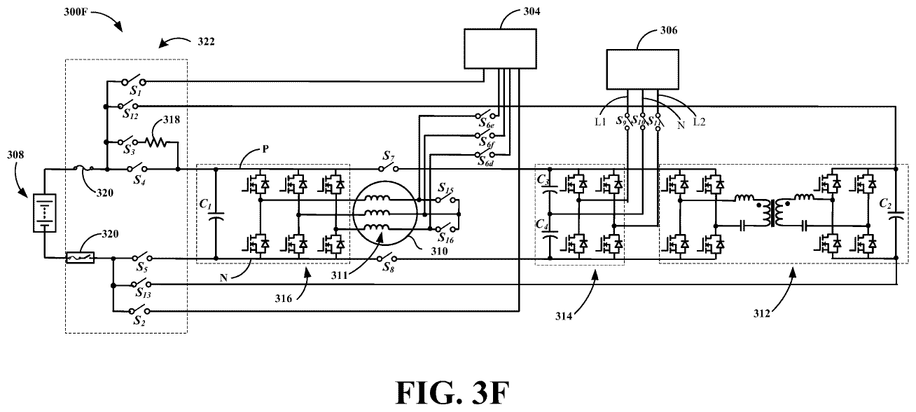

FIGS. 3A, 3B, 3C, 3D, 3E, and 3F each illustrate circuit diagrams of example configurations of an onboard charging system 300, 300A-300F in accordance with the principles of the present disclosure. The onboard charging system 300 includes a charging port 304, a power outlet 306, a battery 308, an electric motor 310, a DC-DC converter 312, a DC-AC converter 314, a bidirectional inverter 316, one or more pre-charge resistors 318, one or more fuses 320, switches S₁-Sₙ, and capacitors C₁-Cₙ. The onboard charging system 300 may also include a battery disconnect unit 322, which includes switches S₁-S₅, S₁₂ and S₁₃, the one or more resistors 318, and the one or more fuses.

In one configuration, as shown in FIG. 3A, a positive terminal of the charging port 304 of the onboard charging system 300A is selectively coupled to a stator winding 311 of the electric motor 310 between the bidirectional inverter 316 and the electric motor 310 via a sixth switch S₆. A negative terminal of the charging port 304 of the onboard charging system 100 is selectively coupled to half bridge switches 324 (i.e., IGBTs), which are connected in parallel to the bidirectional inverter 316, the DC-AC converter 314, and the DC-DC converter 312 via a fourteenth switch S₁₄. Additionally, the positive terminal of the charging port 304 is selectively coupled to the battery via a first switch S₁ and the negative terminal is selectively coupled to the battery via a second switch S₂.

In one configuration, as shown in FIG. 3B, a positive terminal of the charging port 304 of the onboard charging system 300B is selectively coupled, via a sixth switch S₆, between one of the stator windings 311 of the electric motor 310 and the bidirectional inverter 316. In this configuration, the capacitor of the bidirectional inverter 316 is split into two capacitors C₁, C₅ and a negative terminal of the charging port 304 of the onboard charging system 300B is selectively coupled, via a fourteenth switch S₁₄, between the capacitors C₁, C₅ of the bidirectional inverter 316. Additionally, the positive terminal of the charging port 304 is selectively coupled to the battery 308 via a first switch S₁ and the negative terminal is selectively coupled to the battery 308 via a second switch S₂.

In some cases, the configuration shown in FIG. 3B may cause one of the stator windings 311 of the electric motor 310 that is connected to the positive terminal of the charging port 304 to become hot, which can negatively impact the charging performance and/or the performance of the electric motor 310. Accordingly, in another configuration, as shown in FIG. 3C, a positive terminal of the charging port 304 of the onboard charging system 300C is selectively coupled, via a sixth switch S₆, to three separate sub-switches S₆ₐ, S_{6b}, S_{6c} which are selectively coupled between the stator windings 311 of the electric motor 310 and the bidirectional inverter 316. In this configuration, the three sub-switches S₆ₐ, S_{6b}, S_{6c} are actively controlled by a processor (not shown) such that only one of the three sub-switches S₆ₐ, S_{6b}, S_{6c} is closed at any time. The processor (not shown) is configured to monitor the temperatures of the stator windings 311 of the electric motor 310 and to selectively control the three sub-switches S₆ₐ, S_{6b}, S_{6c} to prevent any of the stator windings 311 of the electric motor 310 from exceeding a threshold temperature. In this configuration, the capacitor of the bidirectional inverter 316 is split into two capacitors C₁, C₅ and a negative terminal of the charging port 304 of the onboard charging system 300C is selectively coupled between the two capacitors C₁, C₅ of the bidirectional inverter 316. Additionally, the positive terminal of the charging port 304 is selectively coupled to the battery 308 via a first switch S₁ and the negative terminal is selectively coupled to the battery 308 via a second switch S₂.

In one configuration, as shown in FIG. 3D, a positive terminal of the charging port 304 of the onboard charging system 300D is selectively coupled to a neutral point of the stator windings 311 of the electric motor 310 via a sixth switch S₆. A negative terminal of the charging port 304 of the onboard charging system 300D is selectively coupled to IGBTs, which are connected in parallel to the bidirectional inverter 316, the DC-AC converter 314, and the DC-DC converter 312 via a fourteenth switch S₁₄. Additionally, the positive terminal of the charging port 304 is selectively coupled to the battery 308 via a first switch S₁ and the negative terminal is selectively coupled to the battery 308 via a second switch S₂.

In one configuration, as shown in FIG. 3E, a positive terminal of the charging port 304 of the onboard charging system 300E is selectively coupled to a neutral point of the stator windings 311 of the electric motor 310 via a sixth switch S₆. In this configuration, the capacitor of the bidirectional inverter 316 is split into two capacitors C₁, C₅ and a negative terminal of the charging port 304 is selectively coupled, via a fourteenth switch S₁₄, between the capacitors C₁, C₅ of the bidirectional inverter 316. Additionally, the positive terminal of the charging port 304 is selectively coupled to the battery 308 via a first switch S₁ and the negative terminal is selectively coupled to the battery 308 via a second switch S₂.

In one configuration, as shown in FIG. 3F, the charging port 304 of the onboard charging system 300F may be configured for three-phase alternating current and is selectively coupled to the stator windings 311 of the electric motor 310 via three switches She, Sod, S_{6f} between the electric motor 310 and relay switches (i.e., a fifteenth switch S₁₅ and a sixteenth switch S₁₆). Additionally, the positive terminal of the charging port 304 is selectively coupled to the battery 308 via a first switch S₁ and the negative terminal is selectively coupled to the battery 308 via a second switch S₂.

In some configurations, the one or more fuses 320 are disposed adjacent to the terminals of the battery 308 and are configured to prevent damage to the battery 308 by preventing current flow in excess of a threshold level into or out of the battery 308. In one configuration, the one or more pre-charge resistors 318 are disposed between one of the switches, such as the third switch S₃, and the bidirectional inverter 316. The pre-charge resistors 318 may be configured to slowly charge the capacitors C₁ and/or C₅ of the bidirectional inverter 316 before the bidirectional inverter 316 is powered up and to prevent a large about of current into the bidirectional inverter 316.

The various configurations of the onboard charging systems 300, 300A-300F shown in FIGS. 3A, 3B, 3C, 3D, 3E, and 3F are provided as examples of onboard charging systems and are not intended to be limiting. Those of ordinary skill in the art can and will appreciate that other configurations of the on-board charging systems 300 in accordance with principles of the present disclosure are possible.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An electric vehicle, comprising:
a charging port configured to receive an alternating current (AC) power;
a power outlet configured to provide the AC power to one or more external devices;
a direct current (DC) battery selectively coupled to the charging port via a first switch and a second switch;
a bidirectional inverter configured to convert AC power to DC power and to convert DC power to AC power, the bidirectional inverter is selectively coupled to the battery via a third switch, a fourth switch, and a fifth switch;
an electric motor coupled to the bidirectional inverter and selectively coupled to the charging port via a sixth switch;
a DC-AC converter selectively coupled to the electric motor via a seventh switch and an eighth switch and selectively coupled to the power outlet via a ninth switch, a tenth switch, and an eleventh switch;
a DC-DC converter coupled to the DC-AC converter and selectively coupled to the battery via a twelfth switch and a thirteenth switch;
wherein the charging port is selectively coupled to the bidirectional inverter, the electric motor, or the DC-AC converter via a fourteenth switch; and
a processor configured to control operation of the first switch, the second switch, the third switch, the fourth switch, the fifth switch, the sixth switch, the seventh switch, the eighth switch, the ninth switch, the tenth switch, the eleventh switch, the twelfth switch, the thirteenth switch, and the fourteenth switch based on an operation mode of the electric vehicle.

2. The electric vehicle of claim 1, wherein one or more fuses are disposed adjacent to a positive and a negative terminal of the battery.

3. The electric vehicle of claim 2, wherein during a vehicle to vehicle DC boost mode of the electric vehicle, the processor causes the first switch, the second switch, the third switch, the seventh switch, the ninth switch, the tenth switch, the eleventh switch, the twelfth switch, and the thirteenth switch to be in an open position and the fourth switch, the fifth switch, the sixth switch, and the fourteenth switch to be in a closed position.

4. The electric vehicle of claim 2, wherein during a vehicle to vehicle buck mode of the electric vehicle, the processor causes the first switch, the second switch, the third switch, the fourth switch, the fifth switch, the ninth switch, the tenth switch, and the eleventh switch to be in an open position and the sixth switch, the seventh switch, the eighth switch, the twelfth switch, the thirteenth switch, and the fourteenth switch, to be in a closed position.

5. The electric vehicle of claim 2, wherein during a vehicle to load inverter module mode of the electric vehicle, the processor causes the first switch, the second switch, the third switch, the fourth switch, the fifth switch, the sixth switch, the seventh switch, the eighth switch, and the fourteenth switch to be in an open position and the ninth switch, the tenth switch, the eleventh switch, the twelfth switch, and the thirteenth switch to be in a closed position.

6. The electric vehicle of claim 2, wherein during a vehicle to grid mode of the electric vehicle, the processor causes the first switch, the second switch, the third switch, the fourth switch, the fifth switch, the ninth switch, the tenth switch, and the eleventh switch to be in an open position and the sixth switch, the seventh switch, the eighth switch, the twelfth switch, the thirteenth switch, and the fourteenth switch to be in a closed position.

7. The electric vehicle of claim 2, wherein during a vehicle to home mode of the electric vehicle, the processor causes the first switch, the second switch, the third switch, the fourth switch, the fifth switch, the ninth switch, the tenth switch, and the eleventh switch to be in an open position and the sixth switch, the seventh switch, the eighth switch, the twelfth switch, the thirteenth switch, and the fourteenth switch to be in a closed position.

8. The electric vehicle of claim 2, wherein during an AC charging mode of the electric vehicle, the processor causes the third switch, the fourth switch, the fifth switch, the ninth switch, the tenth switch, the eleventh switch, the first switch, and the second switch to be in an open position and the twelfth switch, the thirteenth switch, the fourteenth switch, the sixth switch, the seventh switch, and the eighth switch to be in a closed position.

9. The electric vehicle of claim 2, wherein during a propulsion mode of the electric vehicle, the processor causes the first switch, the second switch, the sixth switch, the seventh switch, the eighth switch, the ninth switch, the tenth switch, the eleventh switch, the twelfth switch, the thirteenth switch, and the fourteenth switch to be in an open position and close the third switch and the fifth switch to pre-charge an inverter capacitor and then open the third switch and close the fourth switch.

10. The electric vehicle of claim 2, wherein during a direct current fast charging mode of the electric vehicle, the processor causes the third switch, the fourth switch, the fifth switch, the sixth switch, the seventh switch, the eighth switch, the ninth switch, the tenth switch, the eleventh switch, the twelfth switch, the thirteenth switch, and the fourteenth switch to be in an open position and the first switch and the second switch to be in a closed position.

11. An onboard charging system for an electric vehicle, the onboard charging system comprising:
a charging port configured to receive an alternating current (AC) power;
a power outlet configured to provide the AC power to one or more external devices;
a direct current (DC) battery selectively coupled to the charging port via a first switch and a second switch;
a bidirectional inverter configured to convert AC power to DC power and to convert DC power to AC power, the bidirectional inverter is selectively coupled to the battery via a third switch, a fourth switch, and a fifth switch;
an electric motor coupled to the bidirectional inverter and selectively coupled to the charging port via a sixth switch;
a DC-AC converter selectively coupled to the electric motor via a seventh switch and an eighth switch and selectively coupled to the power outlet via a ninth switch, a tenth switch, and an eleventh switch; and
a DC-DC converter coupled to the DC-AC converter and selectively coupled to the battery via a twelfth switch and a thirteenth switch; and
wherein the charging port is selectively coupled to the battery via the thirteenth switch.

12. The onboard charging system of claim 11, wherein a positive terminal of the charging port is selectively coupled to a stator winding of the electric motor between the bidirectional inverter and the electric motor via the sixth switch and a negative terminal of the charging port is selectively coupled to half bridge switch via a fourteenth switch.

13. The onboard charging system of claim 11, wherein a positive terminal of the charging port is selectively coupled to a stator winding of the electric motor between the bidirectional inverter and the electric motor via the sixth switch, and a negative terminal of the charging port is selectively coupled between capacitors of the bidirectional inverter via a fourteenth switch.

14. The onboard charging system of claim 11, wherein a positive terminal of the charging port is selectively coupled to three sub switches via the sixth switch, the three sub switches are each selectively coupled to separate stator windings of the electric motor.

15. The onboard charging system of claim 14, further comprising a processor configured to monitor temperatures of the stator windings and selectively control the three sub switches to prevent any of the stator windings from exceeding a threshold temperature.

16. The onboard charging system of claim 11, wherein a positive terminal of the charging port is selectively coupled to a neutral point of stator windings of the electric motor via the sixth switch, and a negative terminal of the charging port is selectively coupled to insulated gate bipolar transistors that are connected in parallel to the bidirectional inverter, the DC-AC converter, and the DC-DC converter via a fourteenth switch.

17. The onboard charging system of claim 11, wherein a positive terminal of the charging port is selectively coupled to a neutral point of stator windings of the electric motor via the sixth switch, and a negative terminal of the charging port is selectively coupled between capacitors of the bidirectional inverter via a fourteenth switch.

18. The onboard charging system of claim 11, wherein one or more fuses are disposed adjacent to a positive and negative terminal of the battery.

19. The onboard charging system of claim 11, wherein one or more pre-charge resistors are disposed between the third switch and the bidirectional inverter.

20. The onboard charging system of claim 11, further comprising a battery disconnect unit configured to be controlled by a processor and comprising one or more switches, one or more resistors, and one or more fuses.
